(19) United States
(12) Patent Application Publication
(10) Pub. No.: US 2016/0369783 A1
(43) Pub. Date: Dec. 22, 2016

(54) KINETIC ENERGY RECOVERY SYSTEM

(71) Applicant: EDWARDS LIMITED, Crawley (GB)

(72) Inventor: NIGEL PAUL SCHOFIELD, Horsham (GB)

(73) Assignee: Edwards Limited, Crawley (GB)

(21) Appl. No.: 15/181,455

(22) Filed: Jun. 14, 2016

(30) Foreign Application Priority Data
Jun. 16, 2015 (GB) 1510494.6

(51) Int. Cl. F03G 3/08; B60L 11/16; F04C 18/02; F04B 45/04; F04C 23/00; F04C 25/02

(52) U.S. Cl. CPC F03G 3/08; F04C 23/003; F04C 25/02; F04C 18/0215; F04B 45/04; F04C 23/006; B60L 11/16; F04C 2220/10; F04C 2240/80

(57) ABSTRACT

The present invention provides an improved kinetic energy recovery and/or storage system for vehicles or other devices employing kinetic energy recovery systems comprising a flywheel supported for rotation in a first vacuum enclosure for receiving energy from and dissipating energy to one or more parts of a vehicle; a scroll vacuum pumping arrangement having an inlet arranged to be in fluid communication with an outlet of the first vacuum enclosure for evacuating the first vacuum enclosure; and a second vacuum enclosure having an inlet in fluid communication with an exhaust of the scroll pumping arrangement and arranged to be maintained at a pressure less than atmosphere for reducing the pressure at the exhaust of the scroll pumping arrangement, wherein the second vacuum enclosure comprising an outlet through which gas can be pumped periodically for maintaining the second vacuum enclosure at a pressure less than atmosphere.

### CLAIM OF PRIORITY

The present application claims priority under 35 U.S.C. Section 119(b) to Great Britain Application No. 1510494.6, filed on Jun. 16, 2016, the entire content of which is incorporated herein by reference.

### TECHNICAL FIELD

The present invention relates to a kinetic energy recovery and/or storage system. This may be of particular use in a vehicle or to prevent interruption to a power supply.

### BACKGROUND OF THE INVENTION

A kinetic energy recovery system (KERS) is used in vehicles to store energy by rotation of a flywheel, and is typically used to recover energy from a rotating part of the vehicle for example a drive shaft. In this example, a drive shaft is rotated by an engine to cause acceleration of the vehicle. During vehicle braking the energy of the rotating part is lost for instance as heat energy caused by friction between braking members. A kinetic energy recovery system is arranged to receive at least part of this lost energy and to return it to the rotating part when energy is required.

A recovery system comprises a flywheel supported for rotation about an axis. Energy is stored by increased rotational speed of the flywheel. The energy stored is proportional to the moment of inertia and the square of the angular velocity. In order to reduce the moment of inertia and therefore mass of the flywheel, the flywheel must be rotated at a high angular velocity to store sufficient energy (e.g. 100,000 rpm). At these high velocities, frictional resistance between a flywheel and ambient air generates large heat losses which decrease the efficiency of the recovery system. Therefore, the flywheel is located in a vacuum enclosure which is evacuated by a vacuum pump to reduce friction between the flywheel and the surrounding air. However, the energy required to operate the vacuum pump detracts from the energy which can be recovered and returned to other parts of the vehicle.

### SUMMARY OF THE INVENTION

The present invention seeks to provide an improved kinetic energy recovery and/or storage system which may be of particular use in a vehicle to prevent interruption to a power supply.

In a first aspect, the present invention provides a kinetic energy storage system comprising: a flywheel supported for rotation in a first vacuum enclosure for receiving energy from and dissipating energy to one or more parts of a vehicle; a scroll vacuum pumping arrangement having an inlet arranged to be in fluid communication with an outlet of the first vacuum enclosure for evacuating the first vacuum enclosure; a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere.

In a further aspect, the present invention provides a kinetic energy recovery system comprising: a flywheel supported for rotation in a first vacuum enclosure for receiving energy from and dissipating energy to one or more parts of a vehicle; a scroll vacuum pumping arrangement having an inlet arranged to be in fluid communication with an outlet of the first vacuum enclosure for evacuating the first vacuum enclosure; a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere.

In examples of the invention the scroll vacuum pumping arrangement is suitable for continuous operation using only a small amount power and undergoing relatively little wear. The second vacuum enclosure provides a backing or roughing pressure for the scroll vacuum pumping arrangement for reducing the energy required by the pumping arrangement and/or decreasing the pressure which can be attained at the inlet of the pumping arrangement. In this latter regard, a scroll vacuum pump which exhausts at atmosphere may be capable of an ultimate pressure of about 1 mbar, whereas a scroll vacuum pump which exhausts at for example 50 mbar may be capable of an ultimate pressure of about 0.01 mbar. Typically, where it is desirable to generate reduced ultimate pressure a scroll pump may be backed by a primary or roughing pump. However as described in the embodiments the KERS is essentially closed and there is little gas flow from the first vacuum enclosure through the scroll pumping arrangement to the second vacuum enclosure. Therefore, it is sufficient that a second vacuum enclosure is used to provide a backing pressure for the scroll pumping arrangement rather than a primary or roughing pump. The second vacuum enclosure need be evacuated only periodically in order to maintain it at a desired pressure. In this regard, it may be desirable to maintain the pressure in the second vacuum enclosure between about 10 and 100 mbar. Since the system is closed the periodic intervals may be infrequent for example hourly, daily, or weekly, or evacuation may occur when a vehicle is serviced, charged with fuel or electricity, or at specific geographical locations.

The vehicle part which dissipates energy may be the same or a different part to the one that receives energy. The flywheel stores energy by rotation in proportion to its inertia and the square of its rotational speed and may receive energy mechanically from a rotating part of the vehicle or alternatively may be driven by an electrical motor and a generator which converts mechanical energy to electrical energy for driving the motor.

A second vacuum pumping arrangement may be provided and operable for periodically evacuating the second vacuum enclosure to maintain the second vacuum enclosure at a pressure less than atmosphere. A valve arrangement may be provided for resisting upstream fluid flow through the outlet of the second vacuum enclosure and allowing downstream fluid flow.

The second vacuum pumping arrangement may be in fluid communication with the valve arrangement and operable with the valve arrangement for pumping gas from the second vacuum enclosure through the exhaust for maintaining the second vacuum enclosure at a pressure less than atmosphere. In examples of the invention, the second vacuum pumping arrangement may form part of the vehicle, may have a secondary function in the vehicle (for example as part of a braking system) or may be external to and separate from the vehicle.

If the second vacuum pumping arrangement is not included in the vehicle itself, there may be provided a flow line downstream of the valve arrangement which comprises a connector for selective sealed connection with a vacuum line or second vacuum pumping arrangement separate from the vehicle. The valve arrangement may then be operable when connected to cause flow of gas through the exhaust of the second vacuum enclosure for maintaining the second vacuum enclosure at a pressure less than atmosphere. An example of this arrangement may include the provision of a vacuum line or second vacuum pumping arrangement at a gas or petrol station, or charging point, whereby a sealed connection is made for evacuating the second vacuum enclosure coterminous with filling the vehicle with fuel or charging the battery.

A controller may be provided which is configured to control flow of gas from the second vacuum enclosure. The controller may be a processing unit or form part of a vehicle CPU which is connected to the valve arrangement and/or the second vacuum pumping arrangement to emit a signal for initiating enclosure evacuation. The controller may be responsive to an event for initiating evacuation such as the availability of redundant capacity in the second vacuum pumping arrangement or to a sensed pressure in the second vacuum enclosure.

The second vacuum pumping arrangement may comprise a scroll pumping mechanism or a diaphragm pumping mechanism, or an air ejector pumping mechanism. In this last example, a compressed air system of the vehicle may feed air to the air ejector pumping mechanism.

The second vacuum pumping arrangement may be operable to provide a vacuum for use by a separate sub-system of the vehicle for example at a pressure of at least 100 mbar.

Advantageously, the second vacuum enclosure may contain a material, such as a molecular sieve, for absorbing gas exhausted from the first vacuum enclosure.

In another embodiment, in a first condition the scroll pumping arrangement is operable for evacuating the first vacuum enclosure and the second vacuum enclosure provides a backing pressure for the scroll pumping arrangement and in a second condition the scroll pumping arrangement is operable for evacuating the second vacuum enclosure. Therefore, the scroll pumping arrangement provides the vacuum pressure for backing itself.

In one example, a valve arrangement connects for fluid communication the inlet of the scroll pumping arrangement to the outlet of the first vacuum enclosure in the first condition and connects for fluid communication the inlet of the scroll pumping arrangement to the outlet of the second vacuum enclosure in the second condition.

In this way, the valve arrangement connects for fluid communication the exhaust of the scroll pumping arrangement to the inlet of the second vacuum enclosure in the first condition so that the second vacuum enclosure can provide a backing pressure for the scroll pumping arrangement.

The valve arrangement may comprise three valves. In this arrangement, a first valve which when open allows first fluid flow between the inlet of the scroll pumping arrangement and the gas outlet of the first vacuum enclosure in the first condition and resists such first fluid flow in the second condition; a second valve which when open allows second fluid flow between the inlet of the scroll pumping arrangement and the inlet of the second vacuum enclosure in the second condition and resists such second fluid flow in the first condition; and a third valve which when open allows third fluid flow between the exhaust of the scroll pumping arrangement and the inlet of the second vacuum enclosure in the first condition so that the second vacuum enclosure provides a backing pressure for the scroll pumping arrangement and resists such third fluid flow in the second condition.

The valve arrangement may additionally comprise a one-way valve (fourth valve) for resisting upstream fluid flow towards the exhaust of the scroll pumping arrangement in the first condition and allowing downstream fluid flow in the second condition.

A controller may be configured to control the valve arrangement for selecting the first condition or the second condition, for example depending on sensed or determined characteristics of the KERS, such as the pressure in the first or second vacuum enclosures, or the intensity or type of use of the KERS.

In normal use of the KERS the second vacuum enclosure is maintained at a pressure of between 10 and 100 mbar and the first enclosure is maintained at a pressure of between 0.1 and 0.01 mbar.

In a second aspect, the present invention provides a vehicle comprising a kinetic energy recovery system comprising: a flywheel supported for rotation in a first vacuum enclosure for receiving energy from and dissipating energy to one or more parts of a vehicle; a scroll vacuum pumping arrangement having an inlet arranged to be in fluid communication with an outlet of the first vacuum enclosure for evacuating the first vacuum enclosure; a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere; and a second vacuum pumping arrangement and a valve arrangement operable for periodic evacuation of the second vacuum enclosure.

In a third aspect, the present invention provides a vehicle and base station combination comprising a kinetic energy recovery system for recovering kinetic energy of the vehicle, the vehicle comprising: a flywheel supported for rotation in a first vacuum enclosure for receiving energy from and dissipating energy to one or more parts of a vehicle; a scroll vacuum pumping arrangement having an inlet arranged to be in fluid communication with an outlet of the first vacuum enclosure for evacuating the first vacuum enclosure; a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere; a valve arrangement in fluid communication with the exhaust of the second vacuum pumping arrangement for controlling the flow of gas through the exhaust; a first flow line downstream of the valve arrangement comprising a first connector for selective sealed connection with a vacuum line or second vacuum pumping arrangement separate from the vehicle the valve arrangement being operable when connected to cause flow of gas through the exhaust of the second vacuum enclosure for maintaining the second vacuum enclosure at a pressure less than atmosphere; the base station comprising a second vacuum pumping arrangement and a second flow line in fluid communication with an inlet of the second vacuum pumping arrangement, the second flow line comprising a second connector, the first and second connectors being configured to form a sealed connection so that gas can be exhausted from the second vacuum enclosure through the first and second flow lines when the vehicle is located at the base station.

In a fourth aspect, the present invention provides a vehicle comprising a kinetic energy recovery system comprising: a flywheel supported for rotation in a first vacuum enclosure for receiving energy from and dissipating energy to one or more parts of a vehicle; a scroll vacuum pumping arrangement having an inlet arranged to be in fluid communication with an outlet of the first vacuum enclosure for evacuating the first vacuum enclosure; a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere; wherein in a first condition the scroll pumping arrangement is operable for evacuating the first vacuum enclosure and the second vacuum enclosure provides a backing pressure for the scroll pumping arrangement and in a second condition the scroll pumping arrangement is operable for evacuating the second vacuum enclosure.

In a fifth aspect, the present invention provides a method of operating a kinetic energy recovery system, the system comprising: a flywheel supported for rotation in a first vacuum enclosure for receiving energy from and dissipating energy to one or more parts of a vehicle; a scroll vacuum pumping arrangement having an inlet arranged to be in fluid communication with an outlet of the first vacuum enclosure for evacuating the first vacuum enclosure; a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere, wherein the method comprises periodically evacuating the second vacuum enclosure to a pressure less than atmosphere using either a second vacuum pumping arrangement or the scroll pumping arrangement. The method may comprise periodically evacuating the second enclosure to a pressure between 10 and 100 mbar and evacuating the first enclosure to a pressure between 0.1 and 0.01 mbar.

The present invention finds use in any kinetic energy recovery and/or storage systems in addition to that described for vehicles, for example as a kinetic energy storage system for uninterrupted power supply unit.

Other preferred and/or optional aspects of the invention are defined in the accompanying claims.

### BRIEF DESCRIPTION OF THE DRAWING

In order that the present invention may be well understood, some embodiments thereof, which are given by way of example only, will now be described with reference to the accompanying drawing, in which:

FIG. 1 is a schematic representation of a vehicle comprising a recovery system;

FIG. 2 is a schematic representation of a vehicle and base station combination comprising a recovery system;

FIG. 3 is a schematic representation of a vehicle comprising another recovery system; and

FIG. 4 shows the vehicle in FIG. 3 in a second condition of the recovery system.

### DETAILED DESCRIPTION OF THE INVENTION

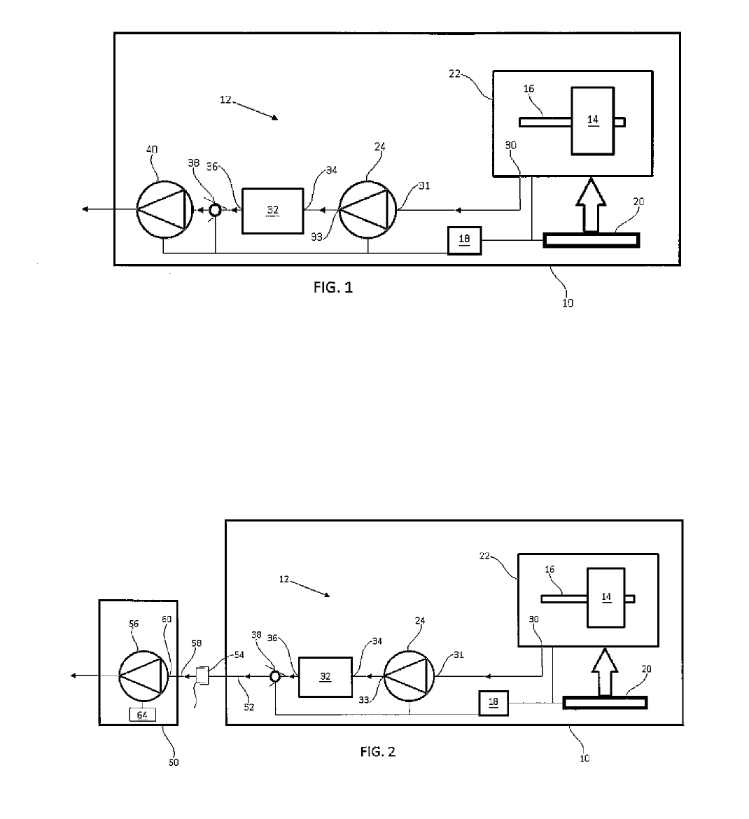

Referring to FIG. 1, a vehicle 10 is shown schematically, which may be an automotive land vehicle, or other type of vehicle in which it is of benefit to capture kinetic energy of the vehicle and selectively release it for improving the performance of the vehicle or conserving energy. Recovery systems of this type are particularly prevalent in racing cars, although they have increasing applicability to energy conservation generally, for example public transportation buses.

Whilst not shown the vehicle typically comprises a plurality of wheels, an engine or power source for driving rotation of the wheels for increasing the vehicles speed, a vehicle drive shaft for transmitting energy from the engine to the wheels and a braking arrangement for reducing rotation of the wheels for decreasing propulsion. Some of these elements may be replaced in other types of vehicle, such as air or water borne vehicles.

The vehicle 10 comprises a kinetic energy recovery system (KERS) 12 having a flywheel 14 supported for rotation by a flywheel shaft 16. The flywheel is arranged to receive energy from a part of the vehicle, such as a drive shaft 20 or other internally moving or rotating part, driven by a vehicle motor, engine or battery and dissipate energy to one or more parts of the vehicle, whether that is the same part or a different part or subsystem of the vehicle.

The recovery system may receive mechanical energy from a rotating or other internally moving part of the vehicle by mechanical connection with that part. Alternatively or additionally, the energy received by the recovery system may be received by an electrical connection. In this latter regard, a part of the vehicle which has kinetic energy may transfer its energy to electrical energy, for example by an alternator, and that electrical energy drives a motor of the flywheel. The arrangement of FIG. 1 applies equally to mechanical or electrical transfer of energy to or from the recovery system.

Referring again to FIG. 1, the recovery system 12 is selectively connected or disconnected from the vehicle part 20, dependent on whether the flywheel is imparting or receiving mechanical or electrical energy in a connected condition or if the recovery system is isolated from other parts from the vehicle in a disconnected condition.

In FIG. 1, the drive shaft 20 is represented schematically as a moving part of the vehicle having kinetic energy for connection with the KERS as shown by the arrow in the drawing. In a mechanical arrangement the flywheel 14 is connected by a gear mechanism for geared rotation of the drive shaft relative to the flywheel. In this regard, the flywheel is typically arranged to rotate faster than the rotating part of the vehicle, for example between about 50,000 and 100,000 rpm compared to the drive shaft which may rotate at about 1000 to 20,000 rpm. A control 18 controls connection between the vehicle part 20 and the KERS 12 according to determined characteristics of the vehicle or system or to input by a user of the system. In this regard, the control may receive input from one or more sensors of the vehicle (not shown) to determine operation of the KERS in any one of the energy receiving condition, energy imparting condition or the disconnected condition. These characteristics include by way of example the relative rotational speed or momentum of the flywheel 14 and the rotating part 20, acceleration of the vehicle, engine air compressor or the state of other subsystems of the vehicle. The control 18 may be a specially programmed digital processing unit forming part of a vehicle management system or may be a bespoke unit for controlling activation of the KERS.

In an alternative arrangement, the system may convert mechanical energy to electrical energy, by for example an alternator, for use by an electrical motor for driving rotation of the flywheel. The motor may form part of the KERS and the alternator may be part of a separate sub-system of the vehicle. Mechanical energy from the flywheel may be transferred directly to a moving or rotating part of the vehicle or may first be converted to electrical energy for transfer to the moving or rotating part or for use by an electrical component for example by an electric motor in a hybrid vehicle.

In a further alternative arrangement, the KERS comprises an electrical motor and generator arrangement which in combination can receive either electrical or mechanical energy for transmission to the flywheel or dissipate mechanical or electrical energy from the flywheel. In this alternative arrangement, the connection to the flywheel is electrical and therefore the vacuum enclosure can be substantially sealed reducing leakage of gas from the enclosure.

Referring in more detail to FIG. 1, in KERS 12 the flywheel 14 is supported for rotation on shaft 16 in a first vacuum enclosure 22 for receiving energy from and dissipating energy to one or more parts of the vehicle 10. The first vacuum enclosure is sealed and is a generally closed system. There is some leakage of gas into the enclosure but mainly the pressure in the enclosure increases due to outgassing from components within the enclosure such as those made from carbon fibre. Therefore once the enclosure is evacuated to a desired pressure of for example 0.01 mbar the pressure increases slowly.

A scroll vacuum pumping arrangement 24 exhausts the gas that accumulates slowly in the first vacuum enclosure through a gas outlet 30. The scroll vacuum pumping arrangement comprises one or more scroll vacuum pumps located in this example external to the vacuum enclosure. Scroll pumping mechanisms per se are known in the vacuum pumping art and need not be described in detail. The scroll mechanism comprises two intermeshing scrolls which orbit relative to each other to trap pockets of gas at an outer inlet which is compressed as orbiting motion causes movement towards an inner outlet. Compression is gradual and avoids sudden changes in pressure. Also, the motion is orbiting without abrupt changes in movement, unlike for example reciprocating pumps. For these reasons and others, scroll pumping mechanisms are energy efficient, quiet and suitable for evacuating the first vacuum enclosure.

The scroll pump has an inlet 31 in fluid communication with the outlet 30 of the first vacuum enclosure for evacuating the first vacuum enclosure and an exhaust 33 in fluid communication with an inlet 34 of a second enclosure 32 for exhausting gas into the enclosure. Since the amount of gas required to be evacuated is small, a second vacuum enclosure, rather than a backing pump, can provide a sufficient backing pressure for the scroll pump. In systems where there is continuous substantial flow of gas to be evacuated a backing pump is required and is operated during operation of a secondary pump. In such systems if a vacuum enclosure were provided to provide a backing pressure it would quickly increase in pressure. In the present arrangement, a vacuum enclosure can provide the necessary backing pressure if it is evacuated periodically. Therefore, the second vacuum enclosure comprises an outlet 36 through which gas can be pumped periodically for maintaining the second vacuum enclosure at a pressure less than atmosphere. In one example, the second vacuum enclosure contains an absorbent material, such as a molecular sieve, for absorbing gas or water vapour exhausted from the first vacuum enclosure, which may extend the periods between evacuation.

Further, as the flow or quantity of gas being pumped is low, the second vacuum enclosure can be evacuated relatively infrequently by a second vacuum pumping arrangement (discussed in more detail below), which may be an existing part of a vehicle or even located away from the vehicle. The periodical requirement for evacuation depends on factors such as the amount that the KERS is used, the type of use, and other characteristics of the system.

A scroll pump which can generate a pressure at its inlet of about 1 mbar if it exhausts to atmosphere can produce a pressure lower than 1 mbar if it exhausts to a pressure lower than atmosphere. In the present arrangement, in normal use of the KERS the second vacuum enclosure is maintained at a pressure of between 10 and 100 mbar and consequently the first enclosure 22 can be maintained at a pressure of between 0.1 and 0.01 mbar. The pressure of the second vacuum enclosure will change during use, gradually increasing between each evacuation, but at a pressure of around 50 mbar the scroll pump can efficiently evacuate the first vacuum enclosure to about 0.01 mbar.

A valve arrangement 38 is in fluid communication with the exhaust 36 of the second vacuum enclosure 32 for controlling the flow of gas through the exhaust. In one arrangement, the valve is actuated by the controller 18 to open or close, or partially open. The valve is opened when evacuation of vacuum enclosure 32 is required and closed when a desired pressure has been attained. In another example, the valve arrangement is a one way valve for resisting the flow of gas upstream towards the exhaust. In this example flow through the valve is allowed only when pressure downstream of the valve is lower than pressure upstream of the valve.

A second vacuum pumping arrangement 40 is in fluid communication with the valve arrangement 38 and therefore the second vacuum enclosure 32 through the valve arrangement. The second vacuum pumping arrangement is operable with the valve arrangement for pumping gas from the second vacuum enclosure through the exhaust 36 for maintaining the second vacuum enclosure at the desired pressure.

The second vacuum pumping arrangement 40 may have a one or more further functions in the vehicle for generating a vacuum pressure in a vehicle part or parts 42. If in this example the second vacuum pumping arrangement is not used constantly for the further function it has redundant capacity which can be used to evacuate the second vacuum enclosure 32. If the controller 18 may be arranged to receive a signal from the second vacuum pumping arrangement 40 when such redundant capacity is available and to operate the valve arrangement 38 for evacuating the second vacuum enclosure 32.

In examples, the second vacuum pumping arrangement 40 comprises another scroll pumping mechanism (possibly of a turbo or super charging mechanism) or a diaphragm pumping mechanism. In another example, the second vacuum pumping arrangement comprises an air ejector pumping mechanism. A compressed air system of the vehicle feeds air to the air ejector pumping mechanism.

In another example of the invention shown in FIG. 2, the second vacuum pumping arrangement is remote from the vehicle 10 and located at a base station 50.

The KERS 12 in FIG. 2 comprises a flow line, or gas conduit, 52 downstream of the valve arrangement 38. The flow line is provided at an end portion with a connector 54 for selective sealed connection with a vacuum line or second vacuum pumping arrangement 56 separate from the vehicle and in or at the base station 50. The valve arrangement 38 is operable (e.g. by controller 18) when connected to cause flow of gas through the exhaust 36 of the second vacuum enclosure 32 for maintaining the second vacuum enclosure at the desired pressure.

The base station 50 comprises a second flow line, or gas conduit, 58 in fluid communication with an inlet 60 of the second vacuum pumping arrangement 56. The second flow line comprises a second connector 62. As shown schematically the first and second connectors 54, 62 are configured to form a sealed connection so that gas can be exhausted from the second vacuum enclosure 32 through the first and second flow lines 52, 58 when the vehicle 10 is located at the base station 50. In this example, the first connector may comprise a female connecting part which engages with a male connecting part of the second connector. The connecting parts may comprise a sealing mechanism such as an 0-ring seated in an annular channel for forming an airtight connection. The connectors may form a push or screw fit connection with complementary engaging formations.

A controller 64 is provided in this example to control activation of the second vacuum pumping arrangement 56 responsive to a connection between the connectors 54, 62.

The base station 50 is typically at a fixed location and evacuation occurs when the vehicle is located at the base station. Therefore there is no requirement for the vehicle to carry a second vacuum pumping arrangement during normal use. The base station may be for example a gas or petrol station, bus depot, garage, or pit-lane. In some arrangements, the base station may comprise a plurality of flow lines 58 and connectors 62 for evacuating a respective plurality of second vacuum enclosure is 32 at the same time. There may be provided more than one second vacuum pumping arrangement 56 at the base station or a single second vacuum pumping arrangement having a multiplicity of flow lines extending therefrom. The base station may itself include a vacuum enclosure evacuated by a vacuum pump for connection to the vehicle for evacuating the second vacuum enclosure 32.

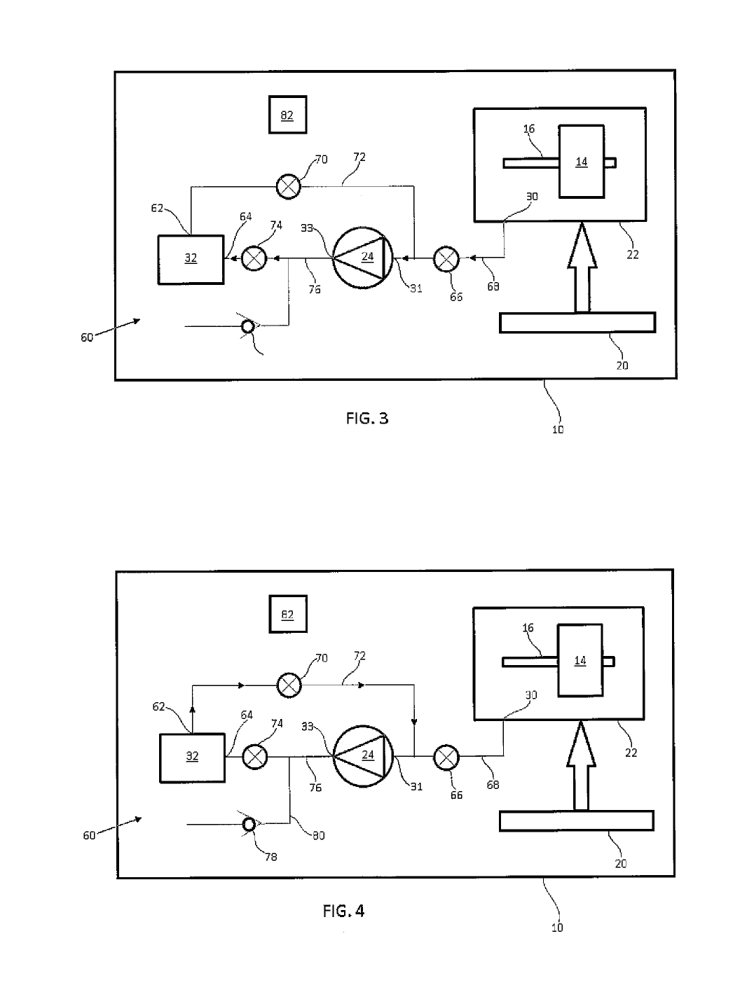

Another embodiment is shown in FIGS. 3 and 4, in which similar features discussed above in relation to FIGS. 1 and 2 are given like reference numerals.

The third embodiment has two conditions. In a first condition of the KERS 60 shown in FIG. 3 the scroll pumping arrangement 24 is operable for evacuating the first vacuum enclosure 22 and the second vacuum enclosure 32 provides a backing pressure for the scroll pumping arrangement. In a second condition of the KERS 60 shown in FIG. 4 the scroll pumping arrangement 24 is operable for evacuating the second vacuum enclosure 32. In this way, the scroll pump 24 provides backing or roughing pressure for itself. A valve arrangement connects for fluid communication the inlet 31 of the scroll pump 24 to the outlet 30 of the first vacuum enclosure 22 in the first condition in FIG. 3. In the second condition in FIG. 4 the valve arrangement connects for fluid communication the inlet 31 of the scroll pump to an outlet 62 of the second vacuum enclosure 32. The valve arrangement connects for fluid communication the exhaust 33 of the scroll pump 24 to the inlet 64 of the second vacuum enclosure in the first condition so that the second vacuum enclosure can provide a backing pressure for the scroll pump.

The valve arrangement in the illustrated example comprises four valves.

A first valve 66 is located in a flow line, or gas conduit, 68 between the inlet 31 of the scroll pump and the gas outlet 30 of the first vacuum enclosure. When the valve is open fluid flow is caused by operation of the scroll pump between the inlet of the scroll pumping arrangement and the gas outlet of the first vacuum enclosure in the first condition. When the valve is closed it resists this fluid flow in the second condition.

A second valve 70 is located in a flow line, or gas conduit, 72 between the inlet 31 of the scroll pump and the outlet 62 of the second vacuum enclosure. When the valve is open it allows fluid flow between the inlet of the scroll pumping arrangement and the inlet of the second vacuum enclosure in the second condition. The valve resists this fluid flow in the first condition.

A third valve 74 is located in a flow line, or gas conduit, 76 between the exhaust 33 of the scroll pump 24 and the inlet 64 of the second vacuum enclosure. When this valve is open it allows fluid flow between the exhaust of the scroll pumping arrangement and the inlet of the second vacuum enclosure in the first condition so that the second vacuum enclosure provides a backing pressure for the scroll pumping arrangement. The valve resists this fluid flow in the second condition.

A fourth valve 78 is located in a flow line, or gas conduit, 80 between the exhaust of the scroll pump 24 and an outlet of the KERS to atmosphere. The fourth valve is preferably a one-way valve as illustrated for resisting upstream fluid flow towards the exhaust of the scroll pumping arrangement in the first condition and allowing downstream fluid flow in the second condition.

A controller 82 is connected by control lines (not shown) to the valve arrangement and may also be connected to enclosures 22, 32, scroll pump 24 and second pump 32, and the vehicle part 20. The controller for part of a CPU of a vehicle or be a bespoke processing component. It is configured to control the valve arrangement for selecting the first condition or the second condition. Such control may be responsive for example to a determination of pressure in the enclosures 22, 32 or operation of the KERS and vehicle part.

In the first condition of KERS 60 shown in FIG. 3 the scroll pump 24 is operated for evacuating enclosure 22 and is provided with a backing pressure by enclosure 32 to improve the ultimate pressure of the scroll pump and/or improve energy efficiency. In FIG. 3, valve 70 is closed and valves 66, 74 are open. Scroll pump 24 is operated to evacuate gas from enclosure 22 through its outlet 30 along flow line 68 to the inlet 31 of the scroll pump and from the exhaust. Gas is not evacuated to atmosphere through valve 78, which remains closed, since the enclosure is at lower pressure than atmosphere. The second enclosure gradually fills with gas as outgases and leakage is evacuated from enclosure 22 and conveyed downstream. Dependent on the specific structure or intensity of use, the second vacuum enclosure may exceed a desired pressure (e.g. 100 mbar) after a period of time such as a minute, an hour, a day. Preferably it is determined for example by a sensor when the pressure in the vacuum enclosure exceeds a predetermined pressure and the controller 82 is responsive to the determination to control the valve arrangement to operate in the second condition.

The second condition is illustrated in FIG. 4. The valve 70 is open and valves 66, 74 are closed. The scroll pump 24 is operated to evacuate gas from enclosure 32 through outlet 62 along flow line 72 to the inlet 31 of the scroll pump. Since valve 74 is closed gas is directed from exhaust 33 along flow line 80 out of the KERS. When the pressure in enclosure 32 is reduced to a predetermined pressure (e.g. 10 mbar) the controller changes operation to the first condition. The time taken to reduce the pressure depends on such things as the volume of the pressure vessel 32, the capacity and compression generated by the scroll pump 24 and the conductance of the flow lines. If the second enclosure contains a desiccant for absorbing gas, it is desirable to replace it when it is saturated or mostly saturated and replacement may occur for example during vehicle servicing.

### KEY TO FEATURES IN FIGURES

10. Vehicle (bus, racing car etc.)
12. Kinetic Energy Recovery System (KERS)
14. Flywheel
16. Flywheel Shaft
18. Controller
20. Rotating Vehicle Part (Drive Shaft etc.)
22. First Vacuum Enclosure
24. Scroll Pumping Arrangement
30. Outlet
32. Second Vacuum Enclosure
34. Second Vacuum Enclosure Inlet
36. Second Vacuum Enclosure Exhaust
38. Valve Arrangement
40. Second Vacuum Pumping Arrangement
42. Vehicle Part(s)
50. Base Station
52. Flow Line/conduit
54. Connector
56. Second Pumping Arrangement/Vacuum line
58. Flow Line/conduit
60. Inlet
62. Second Connector
64. Controller
66. Valve
70. Valve
72. Conduit
74. Valve
76. Conduit
78. Valve
80. Conduit
82. Controller

We claim:

1. A kinetic energy recovery system comprising:
a flywheel supported for rotation in a first vacuum enclosure for receiving energy from and dissipating energy to one or more parts of a vehicle;
a scroll vacuum pumping arrangement having an inlet arranged to be in fluid communication with an outlet of the first vacuum enclosure for evacuating the first vacuum enclosure;
a second vacuum enclosure having an inlet in fluid communication with an exhaust of the scroll pumping arrangement and arranged to be maintained at a pressure less than atmosphere for reducing the pressure at the exhaust of the scroll pumping arrangement, wherein the second vacuum enclosure comprising an outlet through which gas can be pumped periodically for maintaining the second vacuum enclosure at a pressure less than atmosphere; and
a second vacuum pumping arrangement operable for periodically evacuating the second vacuum enclosure to maintain the second vacuum enclosure at a pressure less than atmosphere.

2. The kinetic energy recovery system of claim 1, wherein the second vacuum pumping arrangement comprises a valve arrangement for resisting upstream fluid flow through the outlet of the second vacuum enclosure and allowing downstream fluid flow.

3. The kinetic energy recovery system of claim 1, wherein the second vacuum pumping arrangement is separate from the vehicle and the system comprises a flow line downstream of the valve arrangement comprising a connector for forming a sealed connection with the second vacuum pumping arrangement so that when connected the second vacuum pumping arrangement is operable to cause flow of gas through the outlet of the second vacuum enclosure for maintaining the second vacuum enclosure at a pressure less than atmosphere.

4. The kinetic energy recovery system of claim 1, wherein the second vacuum pumping arrangement forms part of the vehicle.

5. The kinetic energy recovery system of claim 1, wherein the second vacuum pumping arrangement comprises a scroll pumping mechanism or a diaphragm pumping mechanism.

6. The kinetic energy recovery system of claim 1, wherein the second vacuum pumping arrangement comprises an air ejector pumping mechanism and a compressed air system of the vehicle feeds air to the air ejector pumping mechanism.

7. The kinetic energy recovery system of claim 1, wherein the second vacuum pumping arrangement is operable to provide a vacuum for use by a separate sub-system of the vehicle.

8. The kinetic energy recovery system of claim 1, further comprising a controller configured to control flow of gas from the second vacuum enclosure.

9. The kinetic energy recovery system of claim 1, wherein in a first condition the scroll pumping arrangement is operable for evacuating the first vacuum enclosure and the second vacuum enclosure provides a backing pressure for the scroll pumping arrangement and in a second condition the scroll pumping arrangement is operable for evacuating the second vacuum enclosure.

10. The kinetic energy recovery system of claim 9, comprising a valve arrangement which connects for fluid communication the inlet of the scroll pumping arrangement to the outlet of the first vacuum enclosure in the first condition and which connects for fluid communication the inlet of the scroll pumping arrangement to an outlet of the second vacuum enclosure in the second condition.

11. The kinetic energy recovery system of claim 10, wherein the valve arrangement connects for fluid communication the exhaust of the scroll pumping arrangement to the inlet of the second vacuum enclosure in the first condition so that the second vacuum enclosure can provide a backing pressure for the scroll pumping arrangement.

12. The kinetic energy recovery system of claim 10, wherein the valve arrangement comprises:
a first valve which when open allows first fluid flow between the inlet of the scroll pumping arrangement and the gas outlet of the first vacuum enclosure in the first condition and resists such first fluid flow in the second condition;
a second valve which when open allows second fluid flow between the inlet of the scroll pumping arrangement and the inlet of the second vacuum enclosure in the second condition and resists such second fluid flow in the first condition; and
a third valve which when open allows third fluid flow between the exhaust of the scroll pumping arrangement and the inlet of the second vacuum enclosure in the first condition so that the second vacuum enclosure provides a backing pressure for the scroll pumping arrangement and resists such third fluid flow in the second condition.

13. The kinetic energy recovery system of claim 10, wherein the valve arrangement comprises a one-way valve for resisting upstream fluid flow towards the exhaust of the scroll pumping arrangement in the first condition and allowing downstream fluid flow in the second condition.

14. The kinetic energy recovery system of claim 10, comprising a controller configured to control the valve arrangement for selecting the first condition or the second condition.

15. The kinetic energy recovery system of claim 1, wherein the second vacuum enclosure contains a material for absorbing gas exhausted from the first vacuum enclosure.

16. The kinetic energy recovery system of claim 1, wherein in normal use the second vacuum enclosure is maintained at a pressure of between 10 and 100 mbar and the first enclosure is maintained at a pressure of between 0.1 and 0.01 mbar.

17. A vehicle having a base station and a kinetic energy recovery system for recovering kinetic energy of the vehicle, the vehicle comprising:
a flywheel supported for rotation in a first vacuum enclosure for receiving energy from and dissipating energy to one or more parts of a vehicle;
a scroll vacuum pumping arrangement having an inlet arranged to be in fluid communication with an outlet of the first vacuum enclosure for evacuating the first vacuum enclosure;
a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere;
a valve arrangement in fluid communication with the exhaust of the second vacuum pumping arrangement for controlling the flow of gas through the exhaust;
a first flow line downstream of the valve arrangement comprising a first connector for selective sealed connection with a vacuum line or second vacuum pumping arrangement separate from the vehicle the valve arrangement being operable when connected to cause flow of gas through the exhaust of the second vacuum enclosure for maintaining the second vacuum enclosure at a pressure less than atmosphere; and
the base station comprising a second vacuum pumping arrangement and a second flow line in fluid communication with an inlet of the second vacuum pumping arrangement, the second flow line comprising a second connector, the first and second connectors being configured to form a sealed connection so that gas can be exhausted from the second vacuum enclosure through the first and second flow lines when the vehicle is located at the base station.

18. A vehicle having a kinetic energy recovery system comprising:
a flywheel supported for rotation in a first vacuum enclosure for receiving energy from and dissipating energy to one or more parts of a vehicle;
a scroll vacuum pumping arrangement having an inlet arranged to be in fluid communication with an outlet of the first vacuum enclosure for evacuating the first vacuum enclosure; and
a second vacuum enclosure having an inlet in fluid communication with an exhaust of the scroll pumping arrangement and arranged to be maintained at a pressure less than atmosphere for reducing the pressure at the exhaust of the scroll pumping arrangement, the second vacuum enclosure comprising an outlet through which gas can be pumped periodically for maintaining the second vacuum enclosure at a pressure less than atmosphere;
wherein in a first condition the scroll pumping arrangement is operable for evacuating the first vacuum enclosure and the second vacuum enclosure provides a backing pressure for the scroll pumping arrangement and in a second condition the scroll pumping arrangement is operable for evacuating the second vacuum enclosure.
